(19) United States
(12) Patent Application Publication
(10) Pub. No.: US 2026/0267550 A1
(43) Pub. Date: Sep. 10, 2026

(54) ROBOT CONTROL DEVICE AND ROBOT CONTROL SYSTEM

(71) Applicant: FANUC CORPORATION, Yamanashi (JP)

(72) Inventors: Nao OOSHIMA, Yamanashi (JP); Gou INABA, Yamanashi (JP)

(73) Assignee: FANUC CORPORATION, Yamanashi (JP)

(21) Appl. No.: 19/167,359

(22) PCT Filed: Mar. 29, 2023
(86) PCT No.: PCT/JP2023/012943

§ 371 Date: Sep. 19, 2025

(51) Int. Cl. G06F 3/06

(52) U.S. Cl. CPC G06F 3/0655; G06F 3/0604; G06F 3/0679

(57) ABSTRACT

A robot control device according to an embodiment of the present invention comprises an acquisition unit, a storage unit, and an allocation memory unit. The acquisition unit repeatedly acquires the values of variables from an industrial machine. The storage unit writes the values of the variables acquired by the acquisition unit in a storage region for storing the values of the variables. The allocation memory unit memorizes allocation data indicating the location or address of the storage region in which the variables are written.

### TECHNICAL FIELD

The present disclosure relates to a robot control device and a robot control system.

### BACKGROUND ART

There are systems capable of controlling robots from industrial machines such as machine tools. Such systems enable communication between the robot and the industrial machine to monitor mutual status and to exchange requests. The commands of a robot program include functions to communicate with a computerized numerical control (CNC) industrial machine and to access variables for CNC configuration. By acquiring or writing variables for configuration using this command, the robot or the robot control device and the CNC industrial machine can check mutual status and exchange requests.

### CITATION LIST

### Patent Document

Patent Document 1: PCT International Publication No. WO 2020/194752

### DISCLOSURE OF THE INVENTION

### Problems to Be Solved by the Invention

Access to the variables for CNC configuration requires executing access commands within the robot program. Therefore, the CNC industrial machine cannot issue requests to the robot or the robot control device at arbitrary timings and must wait until the access commands are executed by the robot or the robot control device. For the same reason, it is difficult for the robot or the robot control device and the industrial machine to monitor mutual status. The robot and the CNC industrial machine may be synchronized to check mutual status and exchange requests at arbitrary timings. Synchronization of the robot and the CNC industrial machine requires a plurality of signals. However, CNC variables are typically 8-byte or 16-byte variables. Consequently, when the robot or the robot control device acquires a single variable to monitor one status of the CNC industrial machine, the communication data volume becomes massive, and the communication cycle slows down.

A problem to be solved by the embodiments of the present disclosure is to provide a robot control device and a robot control system that can periodically read (acquire) or write variables for the configuration of industrial machines and use the variables as variable data for robots.

### Means for Solving the Problems

A robot control device according to an embodiment includes an acquisition unit, a storage unit, and an allocation storage unit. The acquisition unit repeatedly acquires values of variables from an industrial machine. The storage unit writes the values of the variables acquired by the acquisition unit into a storage region for storing the values of the variables. The allocation storage unit stores allocation data indicating the location or address of the storage region, into which the variables should be written.

### Effects of the Invention

The present disclosure enables the robot control device to read (acquire) or write variables of the industrial machine, in which the variables are usable in the same manner as the variable data for robots.

### BRIEF DESCRIPTION OF THE DRAWINGS

FIG. 1 is a block diagram illustrating an example of the configuration of a control system and main components included in the control system according to an embodiment;

FIG. 2 is a block diagram illustrating an example of the main functions and main components of the control system according to an embodiment;

FIG. 3 is a flowchart illustrating an example of the processing by the processor of the control device in the first embodiment illustrated in FIG. 1;

FIG. 4 is a flowchart illustrating an example of the processing by the processor of the industrial machine in the first and second embodiments illustrated in FIG. 1;

FIG. 5 is a flowchart illustrating an example of the processing by the processor of the control device in the first and second embodiments illustrated in FIG. 1;

FIG. 6 is a flowchart illustrating an example of the processing by the processor of the teaching device in the first and second embodiments illustrated in FIG. 1;

FIG. 7 is a flowchart illustrating an example of the processing by the processor of the control device in the first and second embodiments illustrated in FIG. 1;

FIG. 8 is a flowchart illustrating an example of the processing by the processor of the industrial machine in the first and second embodiments illustrated in FIG. 1;

FIG. 9 is a table illustrating an example of a variable screen displayed on the display device of the teaching device in FIG. 1;

FIG. 10 is a block diagram illustrating an example of the operation of the control device 100 and the industrial machine 200;

FIG. 11 is a flowchart illustrating an example of the processing by the processor of the control device in the second embodiment illustrated in FIG. 1;

FIG. 12 is a table illustrating an example of a variable screen displayed on the display device of the teaching device in FIG. 1;

FIG. 13 is a flowchart illustrating an example of the processing by the processor of the teaching device in the second embodiment illustrated in FIG. 1; and

FIG. 14 is a diagram illustrating an example of an editing screen displayed on the display device of the teaching device in FIG. 1.

### PREFERRED MODE FOR CARRYING OUT THE INVENTION

Hereinafter, control systems according to several embodiments will be described with reference to the drawings. The drawings used in the description of the following embodiments may omit certain components for the purpose of description. In the drawings and throughout this specification, the same reference numerals denote identical or similar elements.

### First Embodiment

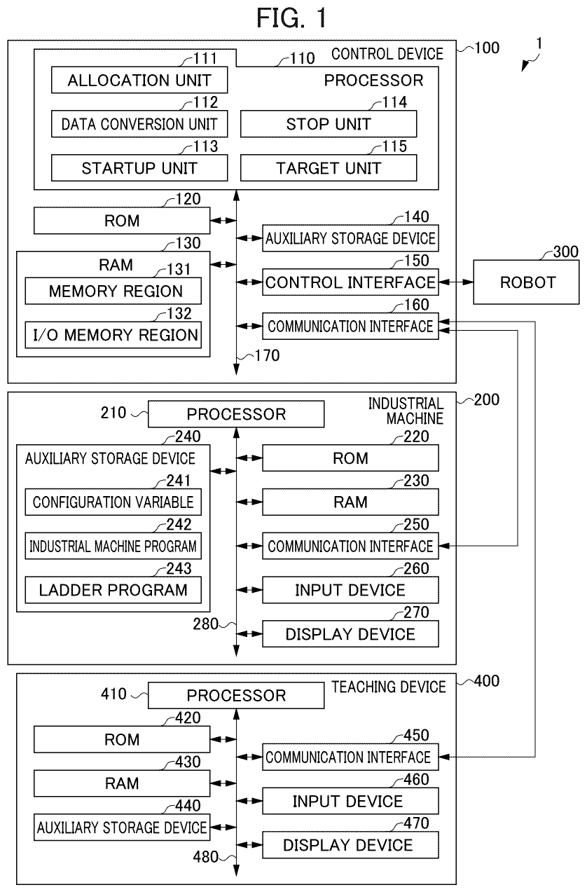

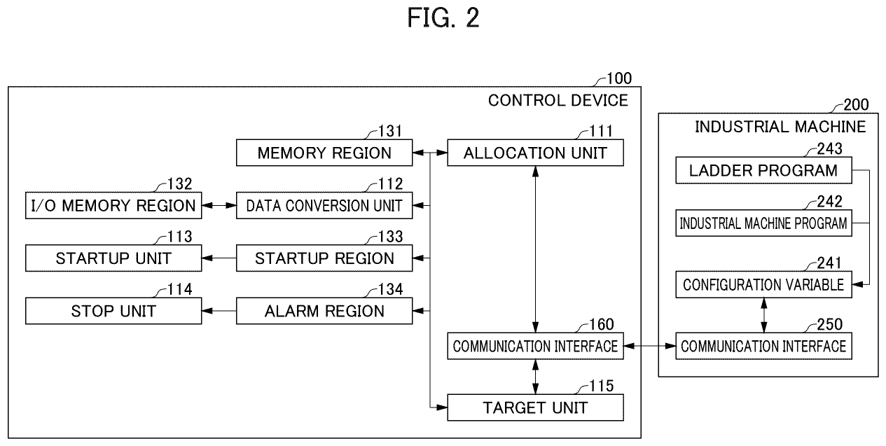

The control system 1 according to an embodiment will be described with reference to FIGS. 1 and 2. FIG. 1 is a block diagram illustrating an example of the main configuration of the control system 1 and components included in the control system 1 according to the embodiment. FIG. 2 is a block diagram illustrating an example of the main functions and configuration of the control system 1 according to the embodiment. The control system 1 is a system that controls a robot 300. As an example, the control system 1 includes a control device 100, an industrial machine 200, a robot 300, and a teaching device 400. The control system 1 is an example of a robot control system.

The control device 100 is a device that controls the robot 300. As an example, the control device 100 includes a processor 110, a read-only memory (ROM) 120, a random-access memory (RAM) 130, an auxiliary storage device 140, a control interface 150, and a communication interface 160. These components are interconnected via a bus 170 or the like. The control device 100 is an example of a robot control device.

The processor 110 executes various computations and processing as the central component of the computer that executes computations and control processing necessary for the operation of the control device 100. The processor 110 may be, for example, a central processing unit (CPU), a micro processing unit (MPU), a system on a chip (SoC), a digital signal processor (DSP), a graphics processing unit (GPU), an application-specific integrated circuit (ASIC), a programmable logic device (PLD), or a field-programmable gate array (FPGA). Alternatively, the processor 110 may be a combination of two or more of these elements. The processor 110 may also include a combination of these elements with hardware accelerators. The processor 110 controls the various components of the control device 100 to implement various functions, based on programs such as firmware, system software, and application software stored in the ROM 120 or the auxiliary storage device 140. The processor 110 executes the processing described later, based on the programs. Part or all of the programs may be embedded within the circuitry of the processor 110.

By executing the above-mentioned programs, the processor 110 functions as, for example, an allocation unit 111, a data conversion unit 112, a startup unit 113, a stop unit 114, and a target unit 115.

The allocation unit 111 specifies where each configuration variable 241 should be stored. The data conversion unit 112 converts the configuration variables 241 into I/O data. The configuration variables 241 will be described later.

The startup unit 113 starts up the robot 300. The stop unit 114 stops the robot 300.

The target unit 115 specifies which configuration variable 241 is targeted for storing values.

The ROM 120 and the RAM 130 are the main storage devices of the computer centered around the processor 110. The ROM 120 is non-volatile memory used exclusively for reading data. The ROM 120 stores, for example, firmware among the above-mentioned programs. The ROM 120 also stores data used by the processor 110 for various processing. The ROM 120 may include a plurality of memory units.

The RAM 130 is memory used for reading and writing data. The RAM 130 serves as a work area for temporarily storing data used by the processor 110 during various processing. The RAM 130 is typically volatile memory. The RAM 130 may include a plurality of memory units.

The RAM 130 includes, for example, two types of memory regions: a memory region 131 and an I/O memory region 132. The memory region 131 is a memory region for storing data other than I/O data. The I/O memory region 132 is a memory region for storing I/O data and is capable of storing I/O data. The I/O data will be described later. The memory region 131 and the I/O memory region 132 may physically reside on the same memory or on different memories. However, in the first embodiment, the RAM 130 may not include the I/O memory region 132. The I/O memory region 132 may be provided in other storage devices such as the ROM 120 or the auxiliary storage device 140, instead of the RAM 130.

The RAM 130 is allocated with a startup region 133 and an alarm region 134. The startup region 133 and the alarm region 134 will be described later.

The auxiliary storage device 140 is an auxiliary storage device of the computer centered around the processor 110. Examples of the auxiliary storage device 140 include an electrically erasable programmable read-only memory (EEPROM), a hard disk drive (HDD), or flash memory. The auxiliary storage device 140 stores, for example, system software and application software among the above-mentioned programs. The auxiliary storage device 140 stores data used by the processor 110 for various processing, data generated by processing in the processor 110, and various configuration values.

The auxiliary storage device 140 or other devices store parameter information, allocation information, and first execution information described later. The allocation information and the first execution information may also be stored in devices other than the control device 100.

The parameter information stores at least one of the Settings related to acquiring the configuration variables 241 from the industrial machine 200, and the settings related to writing the configuration variables 241 to the industrial machine 200. The values of the settings in the parameter information are configured by the user, administrator, or designer of the control system 1, for example. Default values may be set for each setting in the parameter information. The values for each setting in the parameter information may or may not be modifiable. The auxiliary storage device 140 may store a plurality of parameter information sets.

The control interface 150 is an interface for communication between the control device 100 and the robot 300. The control device 100 communicates with the robot 300 via the control interface 150, thereby controlling the robot 300.

The communication interface 160 is an interface, through which the control device 100 communicates with the industrial machine 200 and the teaching device 400, among others. The communication interface 160 may, for example, communicate via a network. Alternatively, the communication interface 160 may communicate without using a network. The network may be a communication network including, for example, a local area network (LAN) or the Internet. The control device 100 communicates with the industrial machine 200 and the teaching device 400, among others, via the communication interface 160.

The bus 170 includes a control bus, an address bus, and a data bus, and transmits signals exchanged among the components of the control device 100.

The industrial machine 200 may be, for example, a machine tool or peripheral equipment of a machine tool. Alternatively, the industrial machine 200 may be another type of machine. The control scheme of the industrial machine 200 is computerized numerical control (CNC). Alternatively, the control scheme of the industrial machine 200 may be numerical control (NC) or another type of scheme. The industrial machine 200 includes, as an example, a processor 210, a ROM 220, a RAM 230, an auxiliary storage device 240, a communication interface 250, an input device 260, and a display device 270. These components are interconnected via a bus 280 or the like.

The processor 210 executes various calculations and processing as the central component of the computer that executes computations and control processing necessary for the operation of the industrial machine 200. The processor 210 may be, for example, a central processing unit (CPU), a micro processing unit (MPU), a system on a chip (SoC), a digital signal processor (DSP), a graphics processing unit (GPU), an application-specific integrated circuit (ASIC), a programmable logic device (PLD), or a field-programmable gate array (FPGA). Alternatively, the processor 210 may be a combination of two or more of these elements. The processor 210 may also include a combination of these elements with hardware accelerators. The processor 210 controls various components of the industrial machine 200 to implement various functions, based on programs such as firmware, system software, and application software stored in the ROM 220 or the auxiliary storage device 240. The processor 210 executes the processing described later, based on these programs. Part or all of the programs may be embedded within the circuitry of the processor 210.

The ROM 220 and the RAM 230 are the main storage devices of the computer centered around the processor 210. The ROM 220 is non-volatile memory used exclusively for reading data. The ROM 220 stores, for example, firmware among the above-mentioned programs. The ROM 220 also stores data used by the processor 210 for various processing. The RAM 230 is memory used for reading and writing data. The RAM 230 serves as a work area for temporarily storing data used by the processor 210 during various processing. The RAM 230 is typically volatile memory.

The auxiliary storage device 240 is the auxiliary storage device of the computer centered around the processor 210. Examples of the auxiliary storage device 240 include an electrically erasable programmable read-only memory (EEPROM), a hard disk drive (HDD), or flash memory. The auxiliary storage device 240 stores, for example, system software and application software among the above-mentioned programs. The auxiliary storage device 240 stores data used by the processor 210 for various processing, data generated by processing in the processor 210, and various configuration values.

The auxiliary storage device 240, the RAM 230 or other devices stores the configuration variables 241. The configuration variables 241 can be modified by the user of the industrial machine 200. The configuration variables 241 define various settings of the industrial machine 200 or the control system 1. The configuration variables 241 behave, for example, like global variables or external variables. The auxiliary storage device 240, the RAM 230 or other devices may store the plurality of configuration variables 241. One configuration variable 241 may include a plurality of values. In this case, each of the plurality of values defines a setting. As an example, in FIG. 1, the configuration variables 241 are illustrated as being stored in the auxiliary storage device 240.

The above-mentioned programs include, for example, an industrial machine program 242 and a ladder program 243. As an example, in FIG. 1, the industrial machine program 242 and the ladder program 243 are illustrated as being stored in the auxiliary storage device 240. The industrial machine program 242 is a program for machining by the industrial machine 200, created by an end user. The ladder program 243 executes processing for operating the industrial machine 200 and coordinating with external devices.

The communication interface 250 is an interface, through which the industrial machine 200 communicates with the control device 100 or other devices. The communication interface 250 may, for example, communicate via the aforementioned network. Alternatively, the communication interface 250 may communicate without using a network. The control device 100 communicates with the industrial machine 200 among others, via the communication interface 250.

The input device 260 receives operations executed by the operator of the industrial machine 200. The input device 260 may include, for example, a keyboard, keypad, touchpad, mouse, or controller. The input device 260 may also be a voice input device.

The display device 270 displays screens for notifying the operator of the industrial machine 200 or others of various information. Examples of the display device 270 may include, for example, a liquid crystal display or an organic EL display. A touch panel may also serve as both the input device 260 and the display device 270. That is, a display panel of the touch panel can serve as the display device 270, and a touch-input pointing device of the touch panel can serve as the input device 260.

The bus 280 includes a control bus, an address bus, and a data bus, and transmits signals exchanged among the components of the industrial machine 200.

The robot 300 may include, for example, a manipulator, a robot arm, or a robot equipped with these components. The robot 300 may be, for example, an articulated robot. The robot 300 includes, as an example, one or more drive units. The robot 300 may also be another type of robot. The robot 300 may include a built-in control device 100.

The teaching device 400 is a device for creating robot programs. The creation of robot programs may involve online teaching, offline teaching, direct teaching, or other programming methods. The teaching device 400 may, for example, be a teaching pendant capable of online teaching. Alternatively, the teaching device 400 may be a personal computer (PC) or similar device that executes software for offline teaching. The control device 100 may include part or all of the functions of the teaching device 400. The robot 300 may include part or all of the functions of the teaching device 400. The teaching device 400 includes, as an example, a processor 410, a ROM 420, a RAM 430, an auxiliary storage device 440, a communication interface 450, an input device 460, and a display device 470. These components are interconnected via a bus 480 or the like. The teaching device 400 is an example of a display device.

The processor 410 executes various calculations and processing as the central component of the computer that executes computations and control processing necessary for the operation of the teaching device 400. The processor 410 may be, for example, a central processing unit (CPU), a micro processing unit (MPU), a system on a chip (SoC), a digital signal processor (DSP), a graphics processing unit (GPU), an application-specific integrated circuit (ASIC), a programmable logic device (PLD), or a field-programmable gate array (FPGA). Alternatively, the processor 410 may be a combination of two or more of these elements. The processor 410 may also include a combination of these elements with hardware accelerators. The processor 410 controls the various components of the teaching device 400 to implement its various functions, based on programs such as firmware, system software, and application software stored in the ROM 420 or the auxiliary storage device 440. The processor 410 executes the processing described later, based on these programs. Part or all of the programs may be embedded within the circuitry of the processor 410.

The ROM 420 and the RAM 430 are the main storage devices of the computer centered around the processor 410. The ROM 420 is non-volatile memory used exclusively for reading data. The ROM 420 stores, for example, firmware among the above-mentioned programs. The ROM 420 also stores data used by the processor 410 for various processing. The RAM 430 is memory used for reading and writing data. The RAM 430 serves as a work area for temporarily storing data used by the processor 410 during various processing. The RAM 430 is typically volatile memory.

The auxiliary storage device 440 is the auxiliary storage device of the computer centered around the processor 410. Examples of the auxiliary storage device 440 include an electrically erasable programmable read-only memory (EEPROM), a hard disk drive (HDD), or flash memory. The auxiliary storage device 440 stores, for example, system software and application software among the above-mentioned programs. The auxiliary storage device 440 stores data used by the processor 410 for various processing, data generated by processing in the processor 410, and various configuration values

The communication interface 450 is an interface, through which the teaching device 400 communicates with the control device 100 or other devices. The communication interface 450 may, for example, communicate via the aforementioned network. Alternatively, the communication interface 450 may communicate without using a network. The teaching device 400 communicates with the control device 100 or other devices via the communication interface 450.

The input device 460 receives operations executed by the operator of the teaching device 400. The input device 460 may include, for example, a keyboard, keypad, touchpad, mouse, or controller. The input device 460 may also be a voice input device.

The display device 470 displays screens for notifying the operator of the teaching device 400 or others of various information. The display device 470 may include, for example, a liquid crystal display or an organic EL display. A touch panel may also serve as both the input device 460 and the display device 470. That is, a display panel of the touch panel can serve as the display device 470, and a touch-input pointing device of the touch panel can serve as the input device 460.

The bus 480 includes a control bus, an address bus, and a data bus, and transmits signals exchanged among the components of the teaching device 400.

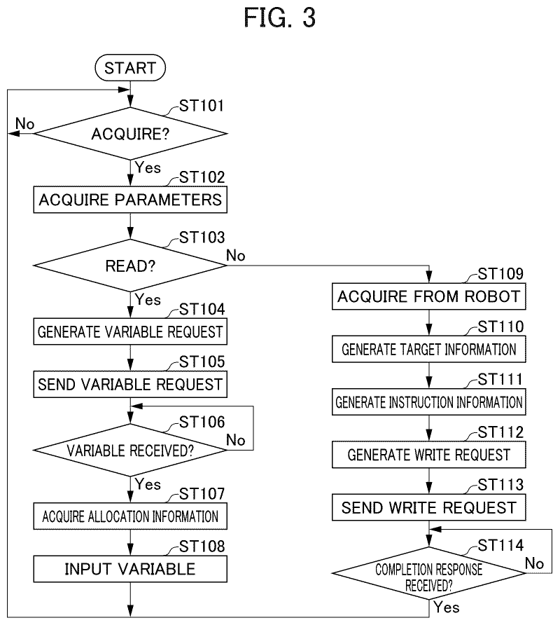

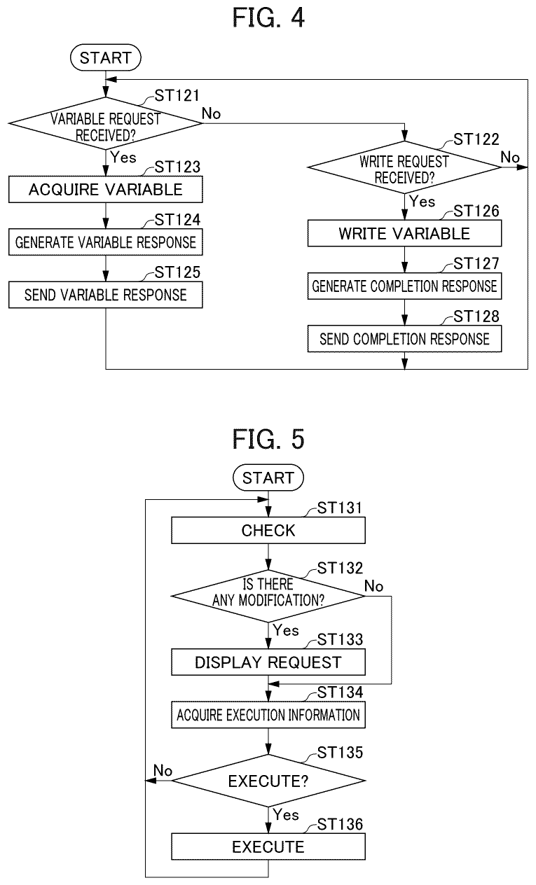

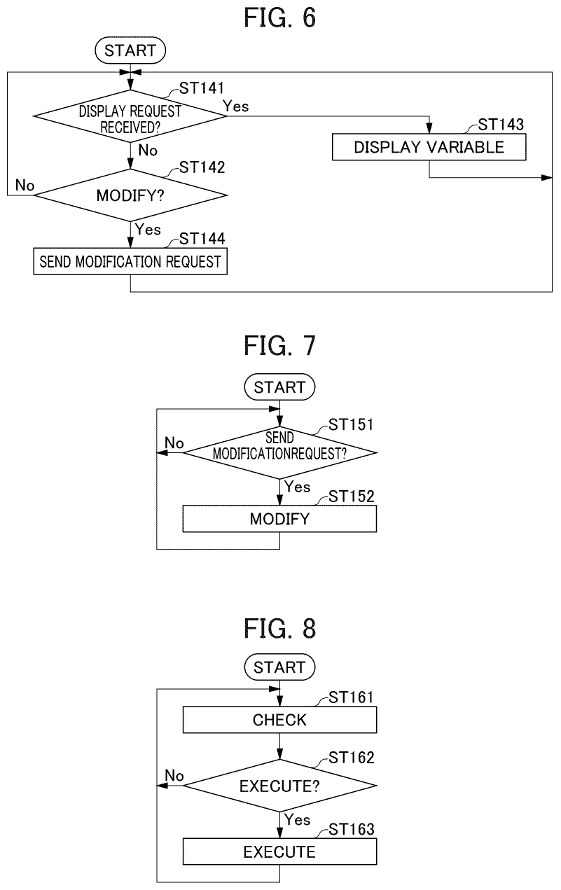

Hereinafter, the operation of the control system 1 according to the first embodiment will be described with reference to FIGS. 3 through 8 and other drawings. The details of the processing described in the following operational description are merely an example, and various processing capable of achieving similar results can be appropriately employed. FIGS. 3, 5, and 7 are flowcharts illustrating examples of the processing executed by the processor 110 of the control device 100. The processor 110 executes, for example, the processing illustrated in FIGS. 3, 5, and 7, based on the programs stored in the ROM 120 or the auxiliary storage device 140. FIGS. 4 and 8 are flowcharts illustrating examples of the processing executed by the processor 210 of the industrial machine 200. The processor 210 executes, for example, the processing illustrated in FIG. 4, based on the programs stored in the ROM 220 or the auxiliary storage device 240. FIG. 6 is a flowchart illustrating an example of the processing executed by the processor 410 of the teaching device 400. The processor 410 executes, for example, the processing illustrated in FIG. 6, based on the programs stored in the ROM 420 or the auxiliary storage device 440.

The processor 110 of the control device 100 executes, for example, the processing illustrated in FIGS. 3, 5, and 7 concurrently or in parallel. The processor 210 of the industrial machine 200 executes, for example, the processing illustrated in FIGS. 4 and 8 concurrently or in parallel.

In Step ST101 of FIG. 3, the processor 110 of the control device 100 determines whether parameter information should be acquired. The processor 110 may determine, for example, that parameter information should be acquired at predetermined time intervals TP. Alternatively, the processor 110 may determine that parameter information should be acquired when the current time has reached or passed a predetermined time CT. Alternatively, the processor 110 may determine that parameter information should be acquired when receiving an input of instructions to acquire parameter information. The input of instructions to acquire parameter information may be, for example, an input from a program executed by the control device 100. Alternatively, the input of instructions to acquire parameter information may be an input from outside the control device 100.

In a case where a plurality of pieces of parameter information exist, the processor 110 may determine whether each piece of parameter information should be acquired individually. Alternatively, in a case of determining that the parameter information should be acquired, the processor 110 determines which piece of parameter information should be acquired.

In a case where a plurality of pieces of parameter information exist, the processor 110 may use different time intervals TP for acquiring each piece of parameter information. In a case where the time TP corresponding to the parameter information has elapsed since the last acquisition of that parameter information, the processor 110 determines this the parameter information should be acquired. The time TP corresponding to each piece of parameter information is included in this parameter information.

For example, assume there are two pieces of parameter information: first parameter information and second parameter information. Assume the time TP corresponding to the first parameter information is time TP1. The first parameter information includes the time TP1. Assume the time TP corresponding to the second parameter information is time TP2. The second parameter information includes the time TP2. In this case, in a case where the time elapsed since the last acquisition of the first parameter information is equal to or greater than the time TP1, the processor 110 determines that the first parameter information should be acquired. Similarly, in a case where the time elapsed since the last acquisition of the second parameter information is equal to or greater than the time TP2, the processor 110 determines that the second parameter information should be acquired.

In a case where a plurality of pieces of parameter information exist, the processor 110 may use different times CT for acquiring each piece of parameter information.

In a case where it is not determined that parameter information should be acquired, the processor 110 determines “No” in Step ST101 and repeats the processing of Step ST101. On the other hand, in a case of determining that the parameter information should be acquired, the processor 110 determines “Yes” in Step ST101 and proceeds to Step ST102.

In Step ST102, the processor 110 acquires parameter information from the auxiliary storage device 140 or another source. In a case where a plurality of pieces of parameter information exist, the processor 110 acquires, for example, the parameter information that has been determined to be acquired in Step ST101.

In Step ST103, the processor 110 determines whether the configuration variables 241 should be acquired from the industrial machine 200. The parameter information includes, for example, information (hereinafter referred to as “configuration information”), which indicates that the configuration variables 241 should be acquired from the industrial machine 200 or that the configuration variables 241 should be written to the industrial machine 200. The processor 110 refers to the configuration information to determine that the configuration variables 241 should be acquired from the industrial machine 200. In a case of determining that the configuration variables 241 should be acquired from the industrial machine 200, the processor 110 determines “Yes” in Step ST103 and proceeds to Step ST104.

As mentioned above, the parameter information includes configuration information. Therefore, determining in Step ST101 whether to acquire the parameter information indicating the acquisition of the configuration variables 241 from the industrial machine 200 can be considered as equivalent to determining whether the configuration variables 241 should be acquired from the industrial machine 200. Similarly, determining in Step ST101 whether to acquire the parameter information indicating writing the configuration variables 241 to the industrial machine 200 can be considered as equivalent to determining whether the configuration variables 241 should be written to the industrial machine 200.

In Step ST104, the processor 110 generates a variable request. The variable request is information requesting the industrial machine 200 to transmit the configuration variables 241. The variable request may include specification information specifying the configuration variables 241 targeted for transmission. The processor 110 acquires the specification information, for example, from the parameter information acquired in Step ST102. The processor 110 then generates a variable request including the specification information.

In Step ST105, the processor 110 instructs the communication interface 160 to transmit the variable request to the industrial machine 200. Upon receiving this transmission instruction, the communication interface 160 transmits the variable request to the industrial machine 200. The transmitted variable request is received via the communication interface 250 of the industrial machine 200.

Meanwhile, in Step ST121 of FIG. 4, the processor 210 of the industrial machine 200 determines whether a variable request has been received via the communication interface 250. In a case where a variable request has not been received, the processor 210 determines “No” in Step ST121 and proceeds to Step ST122.

In Step ST122, the processor 210 determines whether a write request has been received via the communication interface 250. In a case of determining that a write request has not been received, the processor 210 determines “No” in Step ST122 and returns to Step ST121. Thus, the processor 210 remains in a standby state of repeating Steps ST121 and ST122 until a variable request or write request is received.

When a variable request is received while in the standby state of repeating Steps ST121 and ST122, the processor 210 determines “Yes” in Step ST121 and proceeds to Step ST123.

In Step ST123, the processor 210 acquires the configuration variables 241 from the auxiliary storage device 240, the RAM 230, or another source. For example, the processor 210 acquires the configuration variables 241 specified by the specification information included in the variable request received in Step ST121. Alternatively, the processor 210 may acquire all the configuration variables 241.

In Step ST124, the processor 210 generates a variable response. The variable response includes information containing the configuration variables 241 acquired in Step ST123.

In Step ST125, the processor 210 instructs the communication interface 250 to transmit the variable response generated in Step ST124 to the industrial machine 200 that has sent the variable request. Upon receiving this transmission instruction, the communication interface 160 transmits the variable response to the industrial machine 200. The transmitted variable response is received via the communication interface 250 of the industrial machine 200. After completing the processing in Step ST124, the processor 210 returns to Step ST121.

Meanwhile, in Step ST106 of FIG. 3, the processor 110 of the control device 100 waits for a variable response to be received via the communication interface 250. When a variable response is received, the processor 110 determines “Yes” in Step ST106 and proceeds to Step ST107.

In Step ST107, the processor 110 acquires allocation information from the auxiliary storage device 140 or another source. The allocation information stores information about the monitoring variables. The monitoring variables are variables used for inputting the values of the configuration variables 241 or the configuration variables 241 themselves. The monitoring variables are variables that may be targeted for monitoring in the processing illustrated in FIG. 5. For example, upon starting the processing illustrated in FIGS. 3 and 5 or upon starting up the control device 100, the processor 110 assigns the monitoring variables to the RAM 130 or another memory. Alternatively, the auxiliary storage device 140 may store the configuration variables 241. The number of the monitoring variables may be one or more.

The allocation information includes information indicating which monitoring variable should store (record) each configuration variable 241. In a case where a plurality of configuration variables 241 can be stored in one monitoring variable, the allocation information includes information indicating which part of which monitoring variable should store each configuration variable 241. For example, the allocation information defines which monitoring variable should store each configuration variable by the address of the memory region, such as the RAM 130 that has been allocated with the monitoring variable, or the auxiliary storage device 140 that has stored the monitoring variable. In other words, the allocation information includes information indicating which address of the memory region should store each configuration variable 241. Alternatively, the allocation information defines which monitoring variable should store each configuration variable by a variable name or the like. The variable name is an example of information indicating the location in the storage region for storing the configuration variable 241. The allocation information may define the memory region for a plurality of monitoring variables by a single address. For example, the allocation information defines the memory region by the first address of the plurality of monitoring variables and the length from the first to the last of the plurality of monitoring variables. The plurality of monitoring variables are consecutively arranged in the memory region.

The RAM 230 or the auxiliary storage device 240 is an example of a storage region for storing variable values. The region for storing monitoring variables is also an example of a storage region for storing variable values. Accordingly, allocation information is an example of allocation data indicating the location or address of a storage region for storing variable values. In a case where a single monitoring variable can store a plurality of configuration variables 241, the allocation information is an example of allocation data indicating the location or address of a storage region for storing a plurality of variable values. Allocation information that defines the storage region of a plurality of monitoring variables by a single address is an example of allocation data that stores one address indicating a storage region for storing a plurality of variable values. The auxiliary storage device 140 or similar device that stores allocation information is an example of an allocation storage unit that stores the allocation data.

In Step ST108, the processor 110 inputs (stores/writes) the configuration variables 241 received in Step ST106 into the monitoring variables indicated by the allocation information. In a case where the allocation information indicates which address should store the configuration variables 241, the processor 110 inputs (stores) the configuration variables 241 at the address indicated by the allocation information. After completing the processing in Step ST108, the processor 110 returns to Step ST101. As described above, the processor 110 repeats Steps ST101 through ST108. As a result, the processor 110 repeatedly acquires the configuration variables 241 from the industrial machine 200 either periodically or irregularly, and inputs the configuration variables into the monitoring variables.

As described above, by executing the processing in Step ST108, the processor 110 functions as an example of a storage unit that writes the variable values acquired by the acquisition unit into a storage region for storing variable values.

The processor 110 may omit the processing in Step ST101. In this case, the processor 110 starts the processing illustrated in FIG. 3 from Step ST102. After completing the processing in Step ST108, the processor 110 returns to Step ST102. In this case, the processor 110 repeatedly executes Steps ST102 through ST108 without executing the determination in Step ST101, thereby repeatedly acquiring the configuration variables 241 from the industrial machine 200.

As described above, by executing the processing in Steps ST101 through ST108 of FIG. 3, the processor 110 functions as an example of an acquisition unit that repeatedly acquires variable values from the industrial machine.

In Step ST131 of FIG. 5, the processor 110 of the control device 100 checks each monitoring variable. Specifically, the processor 110 acquires the values of the monitoring variables.

In Step ST132, the processor 110 determines whether the values of the monitoring variables have been modified since the previous acquisition. If any value of the monitoring variables has been modified since the previous acquisition, the processor 110 determines “Yes” in Step ST132 and proceeds to Step ST133. On the other hand, if no value of the monitoring variables has been modified since the previous acquisition, the processor 110 determines “No” in Step ST132 and proceeds to Step ST134.

In Step ST133, the processor 110 generates a display request. The display request includes the monitoring variables, or the values of the monitoring variables. The display request is information requesting the teaching device 400 to display the values of the monitoring variables. After generating the display request, the processor 110 instructs the communication interface 160 to transmit the display request to the teaching device 400. Upon receiving this transmission instruction, the communication interface 160 transmits the display request to the teaching device 400. The transmitted display request is received via the communication interface 450 of the teaching device 400.

The processor 410 of the teaching device 400, having received the display request, displays a monitoring variable screen on the display device 470. The monitoring variable screen includes, for example, an image indicating the values of monitoring variables that have been modified.

Meanwhile, in Step ST141 of FIG. 6, the processor 410 of the teaching device 400 determines whether a display request has been received via the communication interface 450. If no display request has been received, the processor 410 determines “No” in Step ST141 and proceeds to Step ST142.

In Step ST142, the processor 410 determines whether the variable values should be modified. For example, in a case where an operation to instruct a modification to the variable value displayed on the input device 460 is executed, the processor 410 determines that the variable value should be modified. In a case where it is not determined that the variable value should be modified, the processor 410 determines “No” in Step ST142 and returns to Step ST141. Thus, the processor 410 remains in a standby state of repeating Steps ST141 and ST142 until receiving a display request or determining that the variable value should be modified.

If a display request is received while the processor 410 is in the standby state of repeating Steps ST141 and ST142, the processor 410 determines “Yes” in Step ST141 and proceeds to Step ST143.

In Step ST143, the processor 410 generates an image corresponding to the variable screen. The processor 410 then instructs the display device 470 to display the generated image. Upon receiving the display instruction, the display device 470 displays the variable screen.

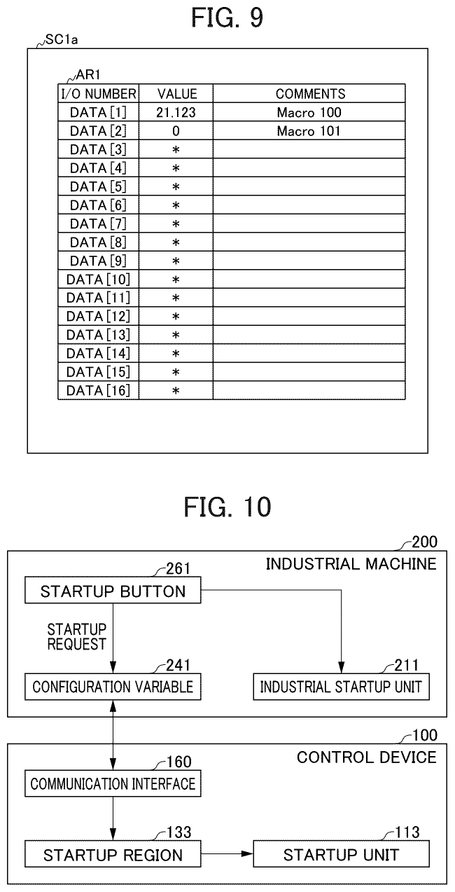

An example of the variable screen will be described with reference to FIG. 9. FIG. 9 is a table illustrating an example of a variable screen SC1a displayed on the display device 470. The variable screen includes the values of the monitoring variables contained in the display request. The variable screen allows for an operation to instruct a modification to the displayed variable values. The variable screen also allows an operation to instruct how the variable values should be modified. For example, the operator of the teaching device 400 can execute such instructions by operating the input device 460. The variable screen SC1a includes, as an example, an area AR1.

The area AR1 indicates the numerical values of each variable. Each of the data [1] through data [16] represents the number assigned to each variable. However, in the state illustrated in FIG. 9, only the variables for the data [1] and the data [2] exist. The variables for the data [3] through data [16] are either unused or non-existent.

Each variable displayed in the area AR1 can be selected by operating the input device 460 or the like.

The value of each variable displayed in the area AR1 can be modified using the input device 460 or the like. When such an operation is executed, the processor 410 determines that the variable values should be modified in Step ST142 of FIG. 6. The modification information described later includes the details of the value modification by the operation.

After completing the processing in Step ST143, the processor 410 returns to Step ST141.

As described above, in Step ST143, the processor 410 functions as an example of a display unit that collaborates with the display device 470 to display the variable values.

While in the standby state of repeating Steps ST141 and ST142, in a case of determining that the variable values should be modified, the processor 410 determines “Yes” in Step ST142 and proceeds to Step ST144.

In Step ST144, the processor 410 generates a modification request. The modification request includes modification information indicating the details of the variable modification. The modification request is information instructing the control device 100 to modify the values of monitoring variables in accordance with the modification information. After generating the modification request, the processor 410 instructs the communication interface 450 to transmit the modification request to the control device 100. Upon receiving this transmission instruction, the communication interface 450 transmits the modification request to the control device 100. The transmitted modification request is received via the communication interface 160 of the control device 100. After completing the processing in Step ST144, the processor 410 returns to Step ST141.

As described above, the processor 410 functions as an example of a modification unit that modifies the variable values by executing the processing in Step ST144.

Meanwhile, in Step ST151 of FIG. 7, the processor 110 of the control device 100 waits for a modification request to be received via the communication interface 160. If a modification request is received, the processor 110 determines “Yes” in Step ST151 and proceeds to Step ST152.

In Step ST152, the processor 110 modifies the values of the monitoring variables in accordance with the modification information contained in the modification request received in Step ST151. After completing the processing in Step ST152, the processor 110 returns to Step ST151.

Meanwhile, in Step ST134 of FIG. 5, the processor 110 acquires first execution information from the auxiliary storage device 140 or another source. The first execution information stores what processing should be executed when the value of each monitoring variable reaches a specific value. The first execution information associates and stores, for example, the information specifying the monitoring variables, and the information indicating the values and the processing to be executed. The first execution information indicates that the associated processing should be executed when the value of the monitoring variable reaches the associated value. As an example, the first execution information stores that the robot 300 should be started up when the monitoring variable stored in the startup region 133 reaches a predetermined value. As another example, the first execution information stores that the robot 300 should be stopped when the monitoring variable stored in the alarm region 134 reaches a predetermined value. The monitoring variable stored in the alarm region 134 indicates that an alarm has occurred in the industrial machine 200 when the value matched the predetermined value.

In Step ST135, the processor 110 determines whether the processing corresponding to the value of the configuration variable 241 should be executed. Specifically, for example, in a case where the value of the monitoring variable matches the value associated in the first execution information, the processor 110 determines that the processing associated with the monitoring variable and the value in the first execution information should be executed. In a case where it is not determined that the processing should be executed, the processor 110 determines “No” in Step ST135 and returns to Step ST131. Conversely, in a case of determining that the processing should be executed, the processor 110 determines “Yes” in Step ST135 and proceeds to Step ST136.

In Step ST136, the processor 110 executes the processing that has been determined to be executed in Step ST135. After completing the processing in Step ST136, the processor 110 returns to Step ST131. As described above, the processor 110 monitors the monitoring variables, and executes the predetermined processing when the value of the monitoring variable reaches a predetermined value. As mentioned earlier, the processor 110 inputs the values of the configuration variables 241 into the monitoring variables through the processing in FIG. 3. Accordingly, the processor 110 monitors the configuration variables through the processing in FIGS. 3 and 5, and executes the predetermined processing when the value of the configuration variable reaches a predetermined value.

An example of the combination of a monitoring variable, a predetermined value, and predetermined processing, which are stored in the first execution information, will be described below. In this example, the monitoring variable is a variable that stores the configuration variable 241 indicating occurrence of an alarm in the industrial machine 200 and the details of the alarm. The predetermined value is a value, such as “1”, indicating occurrence of an alarm. The predetermined processing in this example is to stop the robot 300. For example, the stop unit 114 stops the robot 300. In a case of determining in Step ST134 that the value of the monitoring variable in this example has become “1”, the processor 110 stops the robot 300 in Step ST135. The processor 110, for instance, stops the robot 300 by halting the robot program.

Other examples of predetermined processing include starting up the robot 300, causing the robot 300 to execute a predetermined operation, executing various robot programs, and executing predetermined processing by the control device 100. For example, the processor 110 starts up the robot 300 by executing a robot program that includes a startup command. The startup unit 113, for instance, starts up the robot 300.

The predetermined value may cover a range. For instance, the predetermined value may be “1 to 3”. In this case, the processor 110 executes the predetermined processing when the value of the monitoring variable falls within the range of “1 to 3”.

There may be a plurality of predetermined values. There may be a plurality of predetermined processing. For example, there may be two predetermined values: a first predetermined value and a second predetermined value. Similarly, there may be two predetermined processing: first predetermined processing and second predetermined processing. In this case, the first predetermined processing corresponds to the first predetermined value, and the second predetermined processing corresponds to the second predetermined value. In this case, in a case where the value of the monitoring variable matches the first predetermined value, the processor 110 executes the first predetermined processing. In a case where the value of the monitoring variable matches the second predetermined value, the processor 110 executes the second predetermined processing.

The values of the monitoring variables and the predetermined values are not limited to numerical values. The values of the monitoring variables and the predetermined values may be, for example, strings, dates, Boolean types, pointers, objects, or structures. The predetermined value may also be a value indicating the absence of a value, such as null or nothing.

The predetermined processing will be further described with reference to FIG. 10. For example, assume that the value of a certain configuration variable 241 (hereinafter referred to as “target variable”) is modified in a case where the industrial machine 200 executes a certain operation, or a certain operation is executed on the industrial machine 200 (hereinafter referred to as “value modification trigger”). In this case, the control system 1 can cause the control device 100 to execute predetermined processing in response to the value modification trigger. Such an example will be described with reference to FIG. 10.

FIG. 10 is a block diagram illustrating an example of the operation of the control device 100 and the industrial machine 200. The industrial machine 200 includes an input device 260, such as a startup button 261. The startup button 261 is a button to start and stop the industrial machine 200. When the startup button 261 is operated while the industrial machine 200 is stopped, the industrial machine 200 starts operating. When the startup button 261 is operated while the industrial machine 200 is in operation, the industrial machine 200 stops. When the startup button 261 is operated while the industrial machine 200 is stopped, a startup request signal is output. When the startup button 261 is operated while the industrial machine 200 is in operation, a stop request signal is output. For example, the processor 210 receives an input of the startup request signal or the stop request signal.

When the processor 210 receives an input of a startup request signal, the processor 210 modifies the value of the configuration variable 241 (target variable) to a value indicating that the industrial machine 200 is in operation. Conversely, when the processor 210 receives an input of a stop request signal, the processor 210 modifies the value of the target variable to a value indicating that the industrial machine 200 is stopped. As is evident from the above, the operation of the startup button 261 serves as a value modification trigger, causing the value of the target variable to be modified. Alternatively, the input of the startup request signal or the stop request signal can be considered as a value modification trigger, causing the value of the target variable to be modified.

By executing programs stored in the ROM 220 or the auxiliary storage device 240, the processor 210 functions as an industrial startup unit 211. In response to the operation of the startup button 261 while the industrial machine 200 is stopped, the industrial startup unit 211 starts up the industrial machine program 242 to operate the industrial machine 200.

As described in FIGS. 3 and 4, the processor 110 of the control device 100 acquires the target variable via the communication interface 160. The control device 100 stores the acquired target variable or the value of the target variable in the startup region 133 as a monitoring variable. By monitoring the startup region 133, the processor 110 monitors changes in the value of the target variable. When the value of the target variable changes from the value indicating that the industrial machine 200 is stopped to the value indicating that the industrial machine 200 is in operation, the processor 110 executes predetermined processing, such as starting up the robot 300. For example, the startup unit 113 executes this startup. Conversely, when the value of the target variable changes from the value indicating that the industrial machine 200 is in operation to the value indicating that the industrial machine 200 is stopped, the processor 110 executes predetermined processing, such as stopping the robot 300. The stop unit 114 executes this stopping.

Thus, in the example illustrated in FIG. 10, the operation of the startup button 261 causes not only the industrial machine 200 but also the robot 300 to start or stop.

As described above, by executing the processing in Steps ST135 and ST136, the processor 110 functions as an example of an execution unit that executes predetermined processing corresponding to a predetermined value, in a case where the value of the variable written to the storage region matches the predetermined value.

In a case where it is not determined that the configuration variable 241 should be acquired from the industrial machine 200, i.e., in a case of determining that the configuration variable 241 should be written to the industrial machine 200, the processor 110 determines “No” in Step ST103 of FIG. 3 and proceeds to Step ST109.

In Step ST109, the processor 110 acquires an instruction variable. The instruction variable is a variable that indicates the write content indicated by the instruction information described later. Using the acquisition information in the parameter information acquired in Step ST102, the processor 110 determines which variable should be acquired as an instruction variable. The acquisition information specifies which variable should be acquired as an instruction variable. For example, the processor 110 acquires the instruction variable from the memory region of the robot 300. Alternatively, the processor 110 may acquire an instruction variable from the RAM 130, the auxiliary storage device 140, or an external device. The value of the instruction variable is an example of a value stored in the storage region. Accordingly, by executing the processing in Step ST109, the processor 110 functions as an example of a robot variable acquisition unit that acquires values stored in the storage region.

In Step ST110, the processor 110 generates target information. The target information indicates the target for writing. The target for writing is, for example, a configuration variable 241 that is targeted for writing (storing) a value. The target information, for example, indicates the target for writing or the location of the target for writing, by a variable name or address. Using the target determination information in the parameter information acquired in Step ST102, the processor 110 determines the target for writing. The target determination information specifies which configuration variable 241 is the target for writing the values. The target determination information specifies the configuration variable 241, for example, by a variable name or address. The target determination information is an example of allocation data that indicates the variable in the industrial machine 200 for storing the value acquired by the robot variable acquisition unit. The auxiliary storage device 140 or similar device that stores the target determination information is an example of an allocation storage unit that stores the allocation data.

In Step ST111, the processor 110 generates instruction information. The instruction information indicates the write content of the configuration variable 241. The write content indicated by the instruction information is, for example, the value of the instruction variable acquired in Step ST109. The target information is an example of variable specification data that indicates the variable in the industrial machine, to which the value should be written.

In Step ST112, the processor 110 generates a write request. The write request includes the target information generated in Step ST110 and the instruction information generated in Step ST111. The write request is information instructing the industrial machine 200 to write the content indicated by the instruction information to the target indicated by the target information.

In Step ST113, the processor 110 instructs the communication interface 160 to transmit the write request generated in Step ST112 to the industrial machine 200. Upon receiving this transmission instruction, the communication interface 160 transmits the write request to the industrial machine 200. The transmitted write request is received via the communication interface 250 of the industrial machine 200.

When a write request is received while in the standby state of repeating Steps ST121 and ST122 in FIG. 4, the processor 210 of the industrial machine 200 determines “Yes” in Step ST122 and proceeds to Step ST126.

In Step ST126, the processor 210 writes the value indicated by the instruction information into the configuration variable 241 targeted for writing, which is stored in the auxiliary storage device 240 or RAM 230, in accordance with the write request received in Step ST122. In a case where the value indicated by the instruction information differs from the value of the configuration variable 241 targeted for writing, the processor 210 modifies the value by overwriting. However, in a case where the value indicated by the instruction information is identical to the value of the configuration variable 241 targeted for writing, the processor 210 does not need to overwrite.

In Step ST127, the processor 210 generates a completion response. The completion response is information indicating that the writing of the value based on the write request has been completed.

In Step ST128, the processor 210 instructs the communication interface 250 to transmit the completion response generated in Step ST127 to the control device 100 that has sent the write request. Upon receiving this transmission instruction, the communication interface 250 transmits the completion response to the control device 100. The transmitted completion response is received via the communication interface 160 of the control device 100. After completing the processing in Step ST128, the processor 210 returns to Step ST121.

Meanwhile, in Step ST114 of FIG. 3, the processor 110 of the control device 100 waits for a write request to be received via the communication interface 160. If the write request is received, the processor 110 determines “Yes” in Step ST114 and returns to Step ST101.

As described above, the processor 110 repeats Steps ST101 through ST103 and Steps ST109 through ST114. As a result, the processor 110 repeats periodical or irregular transmission of write requests to the industrial machine 200.

Thus, by executing the processing in Step ST112 in collaboration with the communication interface 250, the processor 110 functions as an example of a transmission unit that repeats periodical transmission of the values acquired by the robot variable acquisition unit and the variable specification data indicating the variables in the industrial machine, to which the values should be written. Alternatively, the processor 110 functions as an example of a transmission unit by executing the processing in Step ST112.

In Step ST161 of FIG. 8, the processor 210 of the industrial machine 200 refers to the auxiliary storage device 240 or the RAM 230 to confirm the values of each configuration variable 241.

In Step ST162, the processor 210 determines whether the processing corresponding to the value of each configuration variable 241 should be executed. For example, in a case where the value of the configuration variable 241 matches the predetermined value specified for that configuration variable 241, the processor 210 determines that the processing should be executed. In a case of determining that the processing should not be executed, the processor 210 determines “No” in Step ST162 and returns to Step ST161. Conversely, in a case of determining that the processing should be executed, the processor 210 determines “Yes” in Step ST162 and proceeds to Step ST163.

In Step ST163, the processor 210 executes the processing corresponding to the predetermined value. After completing the processing in Step ST163, the processor 210 returns to Step ST161. As described above, the processor 210 monitors the configuration variables 241 through the processing in FIG. 8, and executes the predetermined processing when the value of a configuration variable 241 reaches a predetermined value.

According to the control system 1 of the first embodiment, the control device 100 repeatedly reads (acquires) the configuration variables 241 from the industrial machine 200. This enables the control device 100 to monitor the configuration variables of the industrial machine 200. By acquiring the configuration variables 241, the control device 100 can use the configuration variables 241 as variables for the robot. In the case of adding signals to conventional CNC industrial machines, the processing for the added signals needs to be added to the ladder program. However, the end-users of CNC industrial machines typically cannot modify ladder programs. Therefore, end-users must request the industrial machine manufacturers to modify the ladder program. Modification of the ladder program results in significant labor. On the other hand, the configuration variables 241 can be referenced within the machining program, without the need to modify the ladder program.

According to the control system 1 of the first embodiment, the control device 100 uses allocation information that stores one location or one address indicating an allocation storage region for a plurality of variable values. This enables the control device 100 to store a plurality of configuration variables 241 collectively.

According to the control system 1 of the first embodiment, the control device 100 executes predetermined processing corresponding to a predetermined value, in a case where the configuration variable 241 acquired from the industrial machine 200 matches the predetermined value. This enables the industrial machine 200 to operate the control device 100 and the robot 300 using the configuration variables 241.

According to the control system 1 of the first embodiment, the predetermined processing is execution or termination of a robot program. Therefore, in the control system 1 of the first embodiment, the industrial machine 200 can execute or terminate the robot program.

According to the control system 1 of the first embodiment, the control device 100 stops the robot 300, based on the value of the configuration variable 241 indicating occurrence of an alarm. Therefore, the control device 100 of the first embodiment can stop the robot 300 in cases such as occurrence of an abnormality in the control device 100.

According to the control system 1 of the first embodiment, the control device 100 repeatedly acquires instruction variables, and transmits write requests to the industrial machine 200. This enables the control device 100 to rewrite the configuration variables 241 of the industrial machine 200 when the value of an instruction variable changes. Thus, the control device 100 can operate the industrial machine 200 using instruction variables.

According to the control system 1 of the first embodiment, the teaching device 400 modifies the values of the configuration variables 241. This enables the control system 1 of the first embodiment to modify the configuration variables 241 manually.

### Second Embodiment

In the control system 1 of the second embodiment, unlike the first embodiment, the control device 100 converts the configuration variables 241 into input/output (I/O) data and stores the data in an I/O memory region. In the control system 1 of the second embodiment, unlike the first embodiment, the instruction variables are I/O data. The instruction variables are stored in the I/O memory region. The configuration of the control system 1 in the second embodiment is similar to that of the first embodiment, and thus the description is omitted.

In the second embodiment, the auxiliary storage device 140 and other components store I/O memory information described later, instead of the allocation information. Furthermore, in the second embodiment, the auxiliary storage device 140 and other components store second execution information described later, instead of the first execution information.

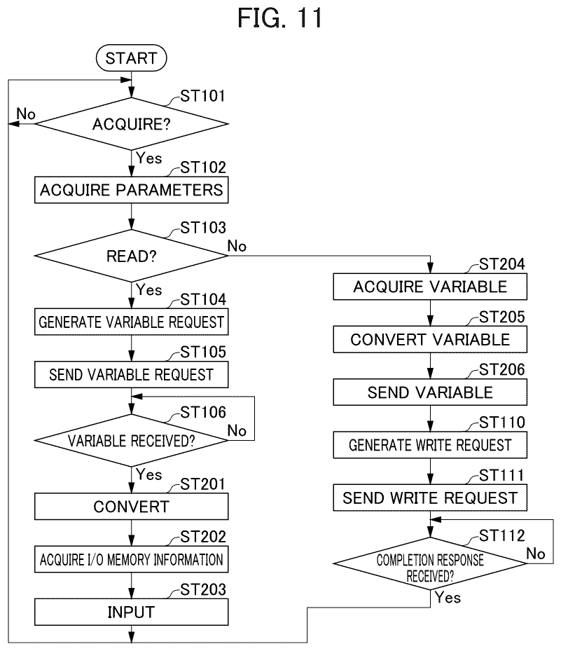

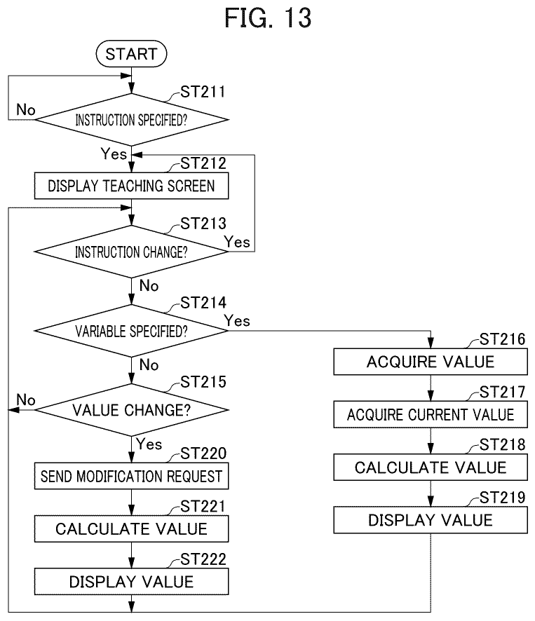

The operation of the control system 1 in the second embodiment will be described below with reference to FIGS. 4 to 8, 11, and 13. The details of the processing described in the following description of operations are merely an example, and various processing capable of achieving similar results may be appropriately utilized. FIG. 11 is a flowchart illustrating an example of the processing executed by the processor 210 of the industrial machine 200. The processor 210 executes the processing illustrated in FIG. 11, based on a program stored in the ROM 220 or the auxiliary storage device 240, for example. FIG. 13 is a flowchart illustrating an example of the processing executed by the processor 410 of the teaching device 400. The processor 410 executes the processing illustrated in FIG. 13, based on a program stored in the ROM 420 or the auxiliary storage device 440, for example.

In the second embodiment, the processor 110 of the control device 100 executes the processing illustrated in FIGS. 5, 7, and 11. The processor 110 executes, for example, the processing illustrated in FIGS. 5, 7, and 11 in parallel or concurrently. In the second embodiment, the processor 210 of the industrial machine 200 executes the processing illustrated in FIGS. 4 and 8, similarly to the first embodiment. In the second embodiment, the processor 410 of the teaching device 400 executes the processing illustrated in FIGS. 6 and 13. The description of the operations of the second embodiment, which are similar to those of the first embodiment, is omitted.

In the second embodiment, the processor 210 of the industrial machine 200 transmits the configuration variables 241 as floating-point data in Step ST125 of FIG. 4. For example, the processor 210 converts the configuration variables 241 into floating-point data before transmission. Alternatively, the processor 210 transmits the configuration variables 241 that are already stored as floating-point data. The industrial machine 200 uses floating-point data such as 32-bit floating-point data or 64-bit double-precision floating-point data. In the case of double-precision floating-point data, the data consists of a total of 64 bits, including a 1-bit sign part, an 11-bit exponent part, and a 52-bit mantissa part, in order from the first part.

Each configuration variable 241 is typically represented by 1 bit. By storing the value of each configuration variable 241 in the individual bits of the floating-point data, 64 configuration variables 241 of 1 bit each can be stored in double-precision floating-point data. The floating-point data with n bits can store n configuration variables 241 of 1 bit each. Note that n is a positive integer.

The industrial machine 200 can also use the configuration variables 241 of 2 or more bits each. In the case of the configuration variable 241 with m bits, the floating-point data uses m bits to store the value of the configuration variable 241. Note that m is an integer of 2 or greater. In the case of using the configuration variables 241 of 2 or more bits each, the floating-point data with n bits can store the values of a plurality of configuration variables 241 up to a total of n bits.

The auxiliary storage device 140 of the control device 100 and the auxiliary storage device 240 of the industrial machine 200 store bit information. The bit information specifies which bit of the floating-point data stores the value of which configuration variable 241.

The processor 210 of the industrial machine 200 uses the bit information to convert the configuration variables 241 into floating-point data. Alternatively, the processor 210 uses the bit information to store the configuration variables 241 in floating-point data format in the auxiliary storage device 240 or the RAM 230.

In the second embodiment, in a case of determining “Yes” in Step ST106 of FIG. 11, the processor 110 of the control device 100 proceeds to Step ST201.

In Step ST201, the processor 110 converts the configuration variables 241 received in Step ST106 into I/O data. The I/O data consists of a plurality of binary values in alignment, such as “0” and “1”, “ON” and “OFF”, or “True” and “False”. Therefore, I/O data is akin to an array of Boolean variables. Binary data can also be viewed as 1-bit binary data. The processor 110 converts the configuration variables 241 into I/O data. Two conversion methods, (i) and (ii), for conversion to I/O data will be described below.

### (i) Conversion Method 1

In the conversion method 1, each bit of a binary representation variable is used as I/O. The received configuration variables 241 are floating-point data represented in binary format. Thus, the processor 110 uses the values of each bit of the floating-point data as I/O data without modification. For example, in a case where the first four bits of the floating-point data are “0100”, the first I/O data is “0”, the second is “1”, the third is “0”, and the fourth is “0”.

### (ii) Conversion Method 2

The conversion method 2 involves rounding the decimal value of the configuration variables 241 to the nearest integer, extracting the absolute value of the integer, and converting the value into binary to use as I/O data. For example, assume the floating-point data before conversion is represented as the decimal number “−1234.567”. In this case, the processor 110 rounds “−1234.567” including the decimal value to “−1234”. Then, the processor 110 calculates the absolute value. Here, the absolute value is “1234”. Furthermore, the processor 110 converts this absolute value into binary data of an integer type. For example, in the case of 16-bit binary data, the value converted into binary is “0000 0100 1101 0011”. The processor 110 uses each bit of this value as I/O data. In the case of this value, the first I/O data is “0”, the second is “0”, the third is “0”, the fourth is “0”, the fifth is “0”, the sixth is “1”, the seventh is “0”, and so forth.

Since the configuration variables 241 are floating-point data, bit-level manipulation may not always be possible. In cases where only specific I/Os of the control device 100 are operated from the processor 210, the users using the conversion method 1 may need to calculate the floating-point data corresponding to the manipulated specific bits, which can be cumbersome. The conversion method 2 reduces this effort and, as a trade-off, results in a smaller amount of transmission data.

Thus, by executing the processing in Step ST201, the processor 110 functions as an example of an I/O conversion unit that converts the values of variables acquired by the acquisition unit into I/O data.

In Step ST202, the processor 110 acquires I/O memory information. The I/O memory information stores information about the I/O memory region 132. The I/O memory information includes information indicating where in the I/O memory region 132 the values of the configuration variables 241 should be stored. For example, the I/O memory information stores which address of the I/O memory region 132 should store the first piece of converted I/O data, thereby indicating where the values of the configuration variables 241 should be stored. For example, in a case where the address for storing the first piece of I/O data is X, the address for storing the second piece of I/O data is X+1. The I/O memory information may also include information indicating which configuration variable 241 is stored at each address. The I/O memory information is an example of allocation data.

In Step ST203, the processor 110 stores the I/O data converted in Step ST201 at the addresses indicated by the I/O memory information in the I/O memory region 132. As a result, the I/O memory region 132 stores the configuration variables 241 in individual bits. After executing the processing in Step ST203, the processor 110 returns to Step ST201. The I/O memory region 132 is an example of a storage region for storing variable values. Among the I/O memory region 132, the region that stores the values of the configuration variables 241 is an example of a storage region for storing variable values.

Thus, by executing the processing in FIG. 11, the processor 110 functions as an example of an acquisition unit that repeatedly acquires the values of variables from the industrial machine.

In the second embodiment, during the processing illustrated in FIG. 5, the processor 110 uses the configuration variables 241 stored in the I/O memory region 132, instead of the monitoring variables.

In the second embodiment, during the processing from Step ST134 to Step ST136, the processor 110 uses second execution information instead of the first execution information. The second execution information stores, for example, what processing should be executed for what values of addresses in the I/O memory region 132. The second execution information associates and stores, for example, information about the addresses in the I/O memory region 132, the corresponding values, and the processing to be executed. The second execution information indicates that predetermined processing is executed when the value of a given address in the I/O memory region 132 reaches the value associated with that address. The second execution information may also be allowed to store what processing should be executed when the respective values of a plurality of addresses in the I/O memory region 132 reach the respective predetermined values. For example, the second execution information may be allowed to store that predetermined processing should be executed when the value at the address Y1 is 1 and the value at the address Y2 is 0.

In the second embodiment, for example, in Step ST135, in a case where the value stored at the address in the I/O memory region 132 matches the value associated in the second execution information, the processor 110 determines that the processing associated with this address and value in the second execution information should be executed. As such, the processor 110 monitors the values stored at the addresses of the I/O memory region 132, and executes predetermined processing when the value reaches a predetermined value. As described earlier, the processor 110 inputs the values of the configuration variables 241 into the I/O memory region 132 through the processing illustrated in FIG. 11. Therefore, the processor 110 monitors the configuration variables 241 through the processing illustrated in FIGS. 11 and 5, and executes predetermined processing when the value of the configuration variable 241 reaches the predetermined value.

In the second embodiment, the modification request instructs the control device 100 to modify the value of the configuration variables 241 stored in the I/O memory region 132 in accordance with the modification information. The processor 110 of the control device 100 modifies the value of the configuration variables 241 stored in the I/O memory region 132 in accordance with the modification information contained in the modification request received.

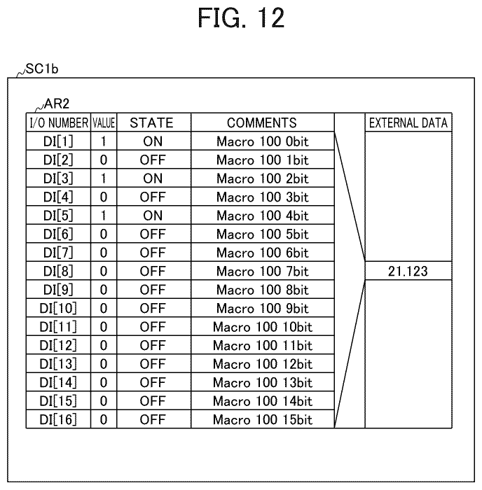

An example of a variable screen in the second embodiment will be described with reference to FIG. 12. FIG. 12 is a table illustrating an example of a variable screen SC1b displayed on the display device 470. The variable screen SC1b is a screen displaying the configuration variables 241 converted with the conversion method (ii). The variable screen SC1b includes, for example, a region AR2.

The region AR2 displays the values of individual bits of a variable in a binary representation. The variable in a binary representation indicated in the region AR2 is the variable converted with (ii) the conversion method 2 for the data [1]. The data [1] is used as a region for setting individual bits. The data [1] corresponds to the value 21.123 when viewed as a 32-bit floating-point number. When the value “21.123” is converted with (ii) the conversion method 2, the resulting value is “21” in decimal and “0000 0000 0001 0101” in binary. In this case, only the lower 16 bits of the binary representation are illustrated. The upper 16 bits are all zeros.

Each bit displayed in the region AR2 can be modified using the input device 460 or similar. When such an operation is executed, the processor 410 determines, in Step ST142 of FIG. 6, that the value of the variable should be modified. The modification information includes the details of the value modification resulting from the operation.

In the second embodiment, the processor 110 modifies the configuration variables 241 stored in the I/O memory region 132, instead of the monitoring variables.

In the second embodiment, in Step ST135, in a case where the value of the configuration variables 241 stored in the I/O memory region 132 matches a predetermined value, the processor 110 determines that the processing corresponding to the value of the configuration variables 241 should be executed.

The teaching device 400 is capable of displaying a screen (hereinafter referred to as the “edit screen”) for verifying and editing the robot programs. The edit screen and the processing related to the edit screen will be described with reference to FIG. 13. For example, in response to receiving an instruction to display the edit screen, the processor 410 of the teaching device 400 starts the processing illustrated in FIG. 13.

In Step ST211 of FIG. 13, the processor 410 of the teaching device 400 waits for a target robot program for editing to be specified. The operator of the teaching device 400 executes an operation to specify the target robot program for editing. In a case of receiving the specification of the target robot program for editing, the processor 410 determines “Yes” in Step ST211 and proceeds to Step ST212.

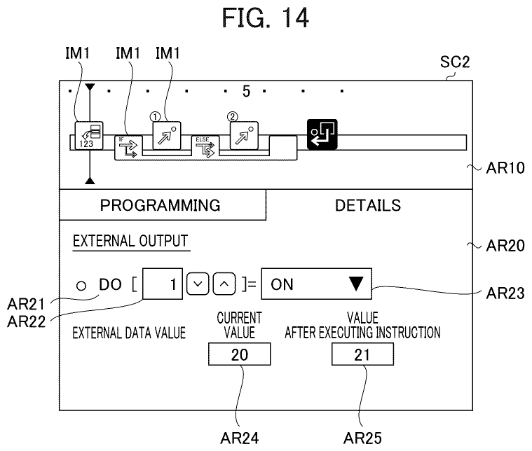

In Step ST212, the processor 410 of the teaching device 400 generates an image corresponding to the edit screen SC2, as illustrated in FIG. 14. The processor 410 then instructs the teaching device 400 to display the generated image. In response to the display instruction, the processor 410 of the teaching device 400 displays the edit screen SC2 on the display device 470.

FIG. 14 is a diagram illustrating an example of the edit screen SC2. The edit screen SC2 is a screen for editing robot programs. The edit screen SC2 includes, as an example, a region AR10 and a region AR20.

The region AR10 is a region displaying the target program for editing. The region AR10 displays the program using one or more images IM1. Each image IM1 represents a command in the program. The images IM1 indicate the details of the commands, for example, through pictograms. The region AR10 may also display each command using text or other characters. The region AR10 can be used for adding, modifying, or deleting the commands.

The region AR10 allows for an operation to specify the target command for editing. For example, each image IM1 serves as a button. By operating an image IM1, the command corresponding to the operated image IM1 becomes the editing target. When no command is specified as the target for editing, for example, the first command is automatically set as the target for editing.

The region AR20 is a region for editing the target command for editing. The region AR20 displays the target command for editing. The region AR20 includes, as an example, regions AR21 to AR25. Depending on the target command for editing, the region AR20 may include regions different from AR21 to AR25.

The region AR21 is a region for displaying the target command for editing. FIG. 14 illustrates “DO [1]” as the command.

“DO [1]” is an output command. The portion “1” of the command is a numeral displayed in the region AR22.

The region AR22 is a region for specifying the configuration variable 241 targeted for operations such as value modifications. The target configuration variable 241 can be specified by inputting a numeral, address, or variable name indicating the configuration variable 241 into the region AR22. Hereinafter, the configuration variable 241 specified as the target for operations such as value modifications is referred to as the “specified variable”. The region AR22 displays numerals, addresses, or variable names that identify the specified configuration variable 241.

The region AR23 is a region for modifying the value of the specified variable. The value of the specified variable can be modified by inputting a value into the region AR23. The region AR23 displays the current value of the specified variable.

The region AR24 displays the current value of data whose value will be modified when the command displayed in the region AR21 is executed (hereinafter referred to as “modification data”). The modification data is, for example, an instruction variable. Accordingly, for instance, the memory region of the robot 300 stores the modification data.

The region AR25 displays the value of the modification data after executing the command.

In Step ST213, the processor 410 determines whether the target command for editing should be modified. For example, in a case where an operation to instruct a modification to the target command for editing is executed, the processor 410 determines that the target command for editing should be modified. In a case where it is not determined that the target command for editing should be modified, the processor 410 determines “No” in Step ST213 and proceeds to Step ST214.

In Step ST214, the processor 410 determines whether an operation to specify a specified variable has been executed. For instance, inputting data into the region AR22 described above is an operation to specify a specified variable. In a case where an operation to specify a specified variable has not been executed, the processor 410 determines “No” in Step ST214 and proceeds to Step ST215.

In Step ST215, the processor 410 determines whether an operation to instruct a modification to the value of the specified variable has been executed. For example, inputting a value into the region AR23 described above is an operation to instruct a modification to the value. In a case where an operation to instruct a modification to the value of the specified variable has not been executed, the processor 410 determines “No” in Step ST215 and returns to Step ST214. In this manner, the processor 410 remains in a standby state of repeating Steps ST213 to ST215, until the processor 410 determines that the target command for editing should be modified, or an operation to specify a specified variable is executed, or an operation to instruct a modification to the value of a specified variable is executed.

While in the standby state of repeating Steps ST213 to ST215, in a case of determining that the target command for editing should be modified, the processor 410 determines “Yes” in Step ST213 and returns to Step ST212. During the processing in Step ST212, the processor 410 updates the display of the edit screen SC1 to a screen corresponding to the modified target command for editing.

When an operation to specify a specified variable is executed while in the standby state of repeating Steps ST213 to ST215, the processor 410 determines “Yes” in Step ST214 and proceeds to Step ST216.

In Step ST216, the processor 410 acquires the value of the specified variable from the RAM 130 of the control device 100 or another source.

In Step ST217, the processor 410 acquires the current value of the modification data.

In Step ST218, the processor 410 calculates the value of the modification data after executing the target command for editing, using the current value of the specified variable.

In Step ST219, the processor 410 displays the value acquired in Step ST217 in the region AR24. The processor 410 also displays the value calculated in Step ST218 in the region AR25. After executing the processing in Step ST219, the processor 410 returns to Step ST212.

When an operation to instruct a modification to the value of the specified variable has been executed while in the standby state of repeating Steps ST213 to ST215, the processor 410 determines “Yes” in Step ST215 and proceeds to Step ST220.

In Step ST220, the processor 410 generates a modification request. The modification request includes modification information indicating the details of the modification to the variable. The modification request is information instructing the control device 100 to modify the value of the configuration variable 241 stored in the I/O memory region 132 in accordance with the modification information. The modification information includes the number or address identifying the specified variable and the modified value of the specified variable. The modified value is the value instructed by the operation to instruct a modification to the specified variable. The modification request is the same as the modification request in Step ST144 of FIG. 6. After generating the modification request, the processor 410 instructs the communication interface 450 to transmit the modification request to the industrial machine 200. Upon receiving this transmission instruction, the communication interface 450 transmits the modification request to the industrial machine 200. The transmitted modification request is received via the communication interface 250 of the industrial machine 200.

Thus, by executing the processing in Steps ST215 and ST220, the processor 410 functions as an example of a modification unit that modifies the value of the variable, based on the editing of the robot program.

In Step ST221, the processor 410 calculates the value of the modification data after executing the target command for editing, using the modified value of the specified variable.

In Step ST222, the processor 410 displays the value calculated in Step ST221 in region AR25. After executing the processing in Step ST222, the processor 410 returns to Step ST214.

Thus, by executing the processing illustrated in FIG. 13, the processor 410 functions as an example of an editing unit that edits the robot program for controlling the robot.

In the second embodiment, in a case of determining “No” in Step ST103, the processor 110 of the control device 100 proceeds to Step ST204.

In Step ST204, the processor 110 acquires the value indicating the content to be written to the configuration variable 241, from the I/O memory region 132 of the RAM 130. This value is, for example, an instruction variable in the format of binary I/O data. This value is, for example, a value converted into I/O data using the same method as Step ST201. The processor 110 converts the instruction variable into I/O data using the same method as Step ST201, and stores the data in the I/O memory region 132.

In Step ST205, the processor 110 converts the value acquired in Step ST204 from binary I/O data to the data format before conversion to I/O data. The data format before conversion is the same format as the configuration variable 241. For example, the data format before conversion is a decimal number.

The data format of the configuration variable 241 is typically not I/O data. Thus, by executing the processing in Step ST205, the processor 110 functions as an example of a conversion unit that converts the value acquired by the robot variable acquisition unit into a data format other than I/O data.

In Step ST206, the processor 110 generates a write request. The write request includes the target information and the instruction information, as in the first embodiment. However, the write content indicated by the instruction information refers to the value converted in Step ST205. After generating the write request, the processor 110 instructs the communication interface 160 to transmit the write request to the industrial machine 200. Upon receiving this transmission instruction, the communication interface 160 transmits the write request to the industrial machine 200. The transmitted write request is received via the communication interface 250 of the industrial machine 200. After executing the processing in Step ST206, the processor 110 returns to Step ST201.

The processor 210 rewrites the configuration variable 241 in accordance with the write request, as in the first embodiment.

The control system 1 of the second embodiment achieves the same effects as the first embodiment.

According to the control system 1 of the second embodiment, the control device 100 converts the configuration variable 241 into I/O data. By preparing signals pre-assigned for specific purposes, such as externally executing or stopping a robot program, operations can be executed with 1-bit data, allowing for reducing data size, and improving the readability of the system. Using 1-bit data reduces the volume of data communication compared to transmitting numerical data.

According to the control system 1 of the second embodiment, the control device 100 uses each bit of a variable in a binary representation as I/O. This enables the control device 100 to include a plurality of settings in a single numerical value.

According to the control system 1 of the second embodiment, the control device 100 includes the I/O memory region 132. Thus, the control device 100 can store instruction variables as I/O data.

According to the control system 1 of the second embodiment, the teaching device 400 modifies the value of the configuration variable 241, based on the editing of the robot program. This enables the control system 1 of the second embodiment to edit robot programs that involve modifications to the value of the configuration variable 241.

The above-described embodiments may also include the following variations. The control system of the embodiment may include a display device without the capability to create robot programs, instead of the teaching device 400.

In the above embodiments, part or all of the processing executed by the teaching device 400 may be executed by the control device 100 or the robot 300. The control device of the embodiment may include part or all of the configurations provided in the teaching device 400.

The processors 110, 210, and 410 may implement part or all of the processing implemented by programs in the embodiments by using hardware circuit configurations.

The programs implementing the processing of the embodiments may be transferred in a state stored in a non-transitory storage medium within the device. However, the device may be transferred without the programs stored. The programs may be transferred separately and written into the device. Such transfer of programs may be achieved, for example, by recording the programs on a removable non-transitory storage medium or through downloads via the Internet or LAN.

Although the embodiments of the present invention have been described above, the embodiments are merely presented as examples and do not limit the scope of the invention. The embodiments of the present invention may be implemented in various forms without departing from the spirit of the invention.

### EXPLANATION OF REFERENCE NUMERALS

1: control system
100: control device
110, 210, 410: processor
111: allocation unit
112: data conversion unit
113: startup unit
114: stop unit
115: target unit
120, 220, 420: ROM
130, 230, 430: RAM
131: memory region
132: I/O memory region
133: startup region
134: alarm region
140, 240, 440: auxiliary storage device
150: control interface
160, 250, 450: communication interface
170, 280, 480: bus
200: industrial machine
211: industrial startup unit
241: configuration variable
242: industrial machine program
243: ladder program
260, 460: input device
261: startup button
270, 470: display device
300: robot
400: teaching device

1. A robot control device, comprising:
an acquisition unit configured to repeatedly acquire a value of a variable from an industrial machine;
a storage unit configured to write the value of the variable acquired by the acquisition unit into a storage region that stores the value of the variable; and
an allocation storage unit configured to store allocation data indicating a location or address in the storage region, into which the variable should be written.

2. The robot control device according to claim 1, further comprising:
an I/O conversion unit configured to convert the value of the variable acquired by the acquisition unit into I/O data, wherein
the storage unit writes the value of the variable converted by the I/O conversion unit into the storage region, and
the storage region exists within an I/O memory region.

3. The robot control device according to claim 2, wherein the acquisition unit is configured to repeatedly acquire values of a plurality of variables,
the allocation storage unit is configured to store the allocation data indicating one of the location or address in the storage region that stores the values of the plurality of variables, and
the storage unit writes the values of the plurality of variables into the storage region, based on the allocation data.

4. The robot control device according to claim 1, further comprising an execution unit configured to execute predetermined processing corresponding to a predetermined value, in a case where the value of the variable written into the storage region matches a predetermined value.

5. The robot control device according to claim 4, wherein the predetermined processing is execution or termination of a robot program.

6. The robot control device according to claim 4, wherein
the variable indicates occurrence of an alarm, and
the predetermined processing is termination of the robot.

7. A robot control device, comprising:
a robot variable acquisition unit configured to acquire a value stored in a storage region;
an allocation storage unit configured to store allocation data indicating a variable of an industrial machine that stores the value acquired by the robot variable acquisition unit; and
a transmission unit configured to periodically and repeatedly transmit the value acquired by the robot variable acquisition unit and variable specification data indicating the variable of the industrial machine, into which the value should be written.

8. The robot control device according to claim 7, wherein
the storage region is an I/O memory region,
the value stored in the storage region is I/O data,
the robot variable acquisition unit acquires the I/O data,
the robot control device further comprises a conversion unit configured to convert the value acquired by the robot variable acquisition unit into a data format other than the I/O data, and
the transmission unit transmits the value converted by the conversion unit to the industrial machine.

9. A robot control system, including a robot control device and a display device,
the robot control device comprising:
an acquisition unit configured to repeatedly acquire a value of a variable from an industrial machine;
a storage unit configured to write the value of the variable acquired by the acquisition unit into a storage region that stores the value of the variable; and
an allocation storage unit configured to store allocation data indicating a location or address in the storage region, into which the variable should be written,
wherein the display device includes a display unit configured to display the value of the variable.

10. The robot control system according to claim 9, wherein the display device further includes a modification unit configured to modify the value of the variable.

11. The robot control system according to claim 9, wherein the display device further includes:
an editing unit configured to edit a robot program for controlling a robot; and
a modification unit configured to modify the value of the variable in accordance with editing of the robot program.
